(19) United States
(12) Patent Application Publication
(10) Pub. No.: US 2011/0271888 A1
(43) Pub. Date: Nov. 10, 2011

(54) Seed tape

(76) Inventor: Benjamen Sauder, Imperial, NE (US)

(21) Appl. No.: 12/799,829

(22) Filed: May 4, 2010

(51) Int. Cl. A01C 1/04; A01C 7/00

(52) U.S. Cl. 111/199; 47/56

(57) ABSTRACT

A seed tape comprising an elongated pliable strip of paper material having seeds positioned thereon with fertilizer positioned therebetween or adjacent thereto. In the preferred embodiment, insecticide is also provided on the seed tape. The spacing and type of seeds on the strip is dependent on the location in a field where the strip will be planted. The type and amount of fertilizer is also positioned on the strip dependent upon the location in the field where that particular portion of the strip will be planted.

### BACKGROUND OF THE INVENTION

1. Field of the Invention

This invention relates to a seed tape and more particularly to a seed tape wherein the spacing of the seeds on the tape is determined upon the soil type of the field in which the seed tape will be planted. More particularly, the invention relates to a seed tape wherein the user may plant, apply insecticide and fertilizer all in one pass. The type of seed is variable along the length of the tape dependent upon the soil type in which the seeds will be planted. Further, the invention relates to a seed tape wherein fertilizer is positioned between the seeds with the type and amount of fertilizer being dependent upon the particular location where the seed tape will be planted in the field having different soil types. Additionally, the invention relates to a seed tape wherein insecticide is positioned on the seed tape closely adjacent to the seed.

Applicant believes that seed tapes will be the next revolution in agriculture. As seen in FIG. 1, which is a depiction of a field which is irrigated by a center pivot irrigation machine or system, it can be seen that various types of soils are located throughout the field with some of the areas of the field being irrigated and some being dryland. As seen, the field has four separate yield requirements, i.e., dryland, sandy ridge, sandy loam and high Ph areas. Each of the different soil types in the field require different seed spacings, different fertilization rates, different insecticide rates, and different types of seeds to achieve the maximum yield potential. In the past, the same type of seeds and spacing thereof were used throughout the field which does not provide the optimum yield for that field.

2. Description of the Related Art

Seed tapes have long been used to facilitate the planting of the seeds in a field or the like. Typical seed tapes and machines for placing the same into the ground are shown in U.S. Pat. Nos. 4,092,936; 4,866,879; 5,165,351; 6,595,149; 6,606,542; 6,701,664; 7,188,449; 7,356,964; and 7,614,181. However, to the best of Applicant's understanding of the prior art seed tapes, each of the prior art seed tapes only have one type of seed placed thereon or therein. In other words, the individual prior art seed tape will only contain a specific hybrid variety such as Hybrid “A” even though Hybrid “A” may not be the desirable hybrid for the entire field since many fields have different soil types. For example, the field to be planted may have areas of loam, sandy loam, river bottom, hills, valleys, ridges and areas of different soil Ph. Thus, although Hybrid “A” may be satisfactory for some areas of the field, other hybrids such as Hybrid “B” or “C” may be the best choice for other areas of the field. Additionally, if the seed tape contains fertilizer, certain types of soils and areas in the field would be more productive with a different type and amount of fertilizer. In summary, it can be appreciated that a seed tape which only has Hybrid “A” seeds therein and one type of fertilizer therein will not produce the maximum yield. Further, if the seeds are equally spaced from one another on the seed tape, that spacing, i.e., population, may not be the proper spacing for all areas of the field. Further, some types, and the amounts thereof, are not the best insecticide for different types of soil.

The seed tape of the invention may be placed in the ground by a GPS planter system such as disclosed in U.S. Pat. No. 5,646,846, after a field has been mapped or surveyed utilizing one or more high-definition soil surveys, yield maps, grid-mapped for a soil analysis, etc.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A seed tape is provided which is comprised of an elongated strip of pliable paper material having a length sufficient so as to be planted in a field having different soil types. Normally, several rows will be planted at the same time with a plurality of the seed tapes being planted in the ground. The strip has spaced-apart seeds positioned thereon with the spacing of the seeds on the strip being variable along the length thereof and being dependent upon the soil type in which that portion of the strip will be planted in predetermined locations in the field. In the preferred embodiment, the type of seeds such as different hybrids will be utilized on the tape for different portions of the field dependent upon the soil types being planted. In the preferred embodiment, fertilizer is positioned on the strip between the seeds with the amount of fertilizer and the type of fertilizer being dependent upon the soil type in which that portion of the strip will be planted in predetermined locations in the field. However, the fertilizer, which may take many forms, may be placed adjacent the seeds rather than between the seeds. Further, the tape itself could be comprised of a fertilizer material or the fertilizer could be impregnated in the tape. In the preferred embodiment, insecticide is positioned on the tape closely adjacent the seeds or between the seeds.

The seed tape may also be designed to be adaptable to different types of soil grades with the spacing of the seeds, type of seeds, fertilizer, etc. being chosen to achieve optimum yield results on sloped areas of the field.

It is therefore the principal object of the invention is to provide a seed tape having seeds positioned thereon with the type of seeds and the spacing thereof being dependent upon the soil type in which the tape will be planted.

A further object of the invention is to provide a seed tape which will correspond to different soil types within the field so as to achieve the maximum yield potential.

A further object of the invention is to provide a seed tape wherein fertilizer is positioned on the tape between the seeds thereof or adjacent the seeds with the type of fertilizer and amount of fertilizer on the tape being chosen dependent upon the soil type in which the tape will be planted.

A further object of the invention is to provide a seed tape which has insecticide positioned thereon.

Yet another object of the invention is to provide a seed tape which will be best suited for different soil types and different soil grades.

A further object of the invention is to provide a seed tape which will improve crop yields.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic view of a typical field irrigated by a center pivot irrigation system with FIG. 1 illustrating that the field has different soils and soil grades; and

FIG. 2 is a perspective view of the seed tape of this invention.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

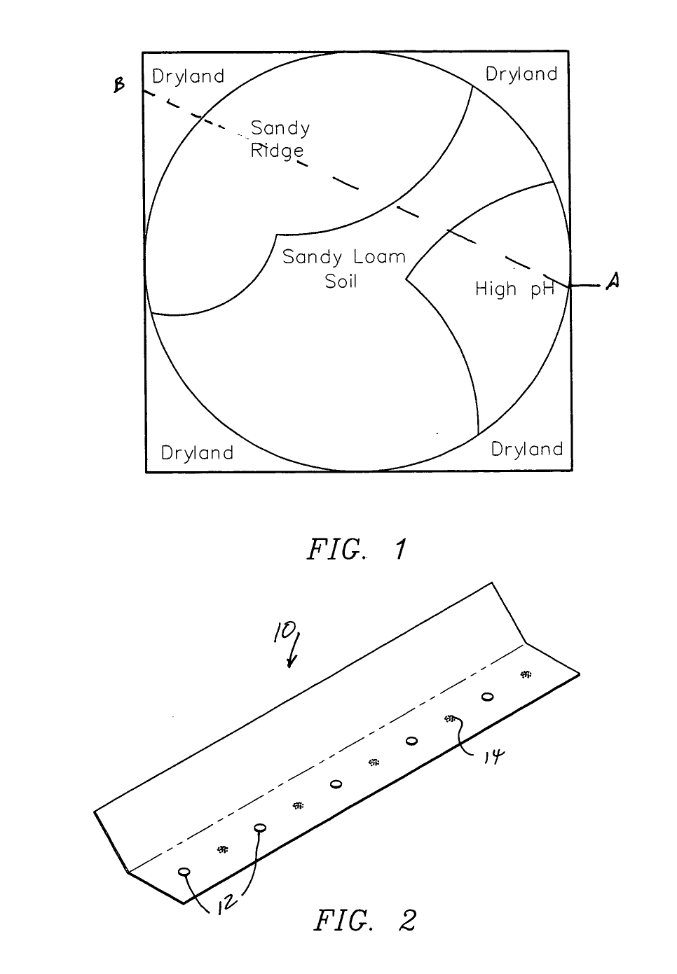

FIG. 1 illustrates a typical field which is irrigated by a center pivot irrigation system which results in dryland farming at the four corners of the field but which irrigates a circular area within the field. As seen in FIG. 1, the type of soil within the field varies considerably and includes a sandy ridge area, a sandy loam soil area, dryland areas and an area of high Ph. If the field is planted in conventional fashion, the seed populations planted would remain the same for the entire field even though different soil types and areas require a variation in the seed population to achieve maximum yield. Further, some types of soil require different hybrids or seed types to provide the greatest yield potential. Additionally, the different locations of the field require different amounts and types of fertilizer. Further, insecticides must be applied to different areas of the field.

In an effort to achieve the greatest yield potential, Applicant has provided a seed tape which is illustrated in perspective form in FIG. 2 and which is designated by the reference numeral 10. Seed tape 10 is comprised of a highly pliable paper material which may be folded upon itself to cover the seeds 12 and the fertilizer 14 positioned therebetween. The spacing of the seeds 12 along the length of the seed tape 10, which will normally be several hundred feet, is dependent upon the particular soil type in which the tape will be planted. The type of seed or seed hybrids chosen will also be dependent upon the soil types in which that particular part of the tape will be planted therein. The fertilizer 14 is preferably positioned between the seeds to achieve maximum nutrient feeding of the seeds. However, the fertilizer could be positioned adjacent the seeds. Additionally, the tape itself could be impregnated with fertilizer or be comprised of a fertilizer material. Additionally, the fertilizer could take many forms, i.e., gas, liquid, dry, gelatinous, etc. The type and amount of fertilizer 14 placed between the seed will be also dependent upon the soil type in which that part of the tape will be planted. In the preferred embodiment, insecticide is also applied to the tape closely adjacent the seeds so that the insecticide will reach the roots of the seeds in a more efficient manner.

Assuming that the field of FIG. 1 is to be planted from location A to location B in a plurality of spaced-apart rows as is common in the agricultural industry, several rolls or boxes of the seed tape 10 will be mounted on a planting unit so as to plant several rows of the seed tapes in one pass. The first portion of the lengths of the seed tapes 10 will have a particular seed type and spacing and the fertilizer and insecticide on the tape 10 will also be the best suited for the high Ph area of the field. The next length of the seed tapes 10 will be planted in the sandy loam soil area and will have a seed spacing, seed type, fertilizer type and amount and insecticide chosen as best suited for the sandy loam soil. The next length of the seed tapes 10 will have a seed population or spacing, seed type, fertilizer type and amount and insecticide chosen to best be suited for the sandy ridge area of the field. The next length of the seed tapes will have a seed spacing or population, seed type, fertilizer type and amount and insecticide best suited for the dryland portion of the field to point B.

Upon reaching point B, the planting equipment will be turned around and will proceed from point B to point A with the seed tapes 10 being dependent upon the soil areas between points B and A.

Normally, the field will have been mapped so as to precisely locate the different soil types and the planting equipment will be GPS controlled so that the proper seed tape planting will occur.

Thus, it can be seen that a novel seed tape has been provided which may have different types of hybrid seeds positioned thereon with spacings therebetween, as well as fertilizer and insecticide being positioned on the tape. The types of seeds, the spacing therebetween, the types and amounts of fertilizer and types and amounts of insecticide on the tape member being chosen for the particular type of soil that the seed tape will be planted.

Thus, it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A seed tape, comprising:
an elongated flexible tape member;
a plurality of longitudinally spaced-apart first seeds secured to said tape member for a predetermined length of said tape member;
a plurality of longitudinally spaced-apart second seeds secured to said tape member for a predetermined length of said tape member;
fertilizer positioned on said tape member adjacent said first seeds; and
fertilizer positioned on said tape member adjacent said second seeds.

2. The seed tape of claim 1 wherein the spacing of said seeds is predetermined to achieve proper plant population.

3. The seed tape of claim 2 wherein the spacing of said first seeds is different than the spacing of said second seeds.

4. The seed tape of claim 1 wherein the fertilizer adjacent said first seeds is different than the fertilizer adjacent said second seeds.

5. The seed tape of claim 1 wherein an insecticide material is positioned on said seed tape.

6. The seed tape of claim 1 wherein said first and second seeds are predetermined through the use of soil mapping methods.

7. The seed tape of claim 1 wherein said seeds are predetermined through the use of a soil survey of the field being planted.

8. The seed tape of claim 1 wherein said first seeds are first hybrid seeds and wherein said second seeds are second hybrid seeds.

9. The seed tape of claim 1 wherein said fertilizer is positioned between said seeds.

10. A seed tape, comprising:
an elongated flexible tape member;
a plurality of longitudinally spaced-apart first hybrid seeds secured to said tape member for a predetermined length of said tape member; and
fertilizer positioned on said tape member adjacent said first hybrid seeds.

11. The seed tape of claim 10 wherein the spacing of said hybrid seeds is predetermined to achieve proper plant population.

12. The seed tape of claim 1 wherein the type of fertilizer is varied along the length of the tape member.

13. The seed tape of claim 1 wherein the amount of fertilizer is varied along the length of the tape member.

14. The seed tape of claim 10 wherein an insecticide material is positioned on said seed tape.

15. The seed tape of claim 10 wherein the type of hybrid seeds is predetermined through the use of soil mapping methods.

16. The seed tape of claim 10 wherein the hybrid seed is determined through the use of a soil survey of the field being planted.

17. The method of planting a field having different soil types throughout, comprising the steps of:
providing an elongated flexible tape member;
positioning a plurality of longitudinally spaced-apart first and second hybrid seeds on said tape member;
and placing the tape member in the field with the first and second hybrid seeds being positioned on the tape member corresponding to the location in the field corresponding to different soil types in the field.

18. The method of claim 17 wherein the spacing of the seeds on the tape member and the hybrid thereof being chosen based upon the soil type of the field wherein the tape member is to be planted.

19. The method of claim 17 wherein fertilizer is positioned on said tape member adjacent said seeds.

20. The method of claim 19 wherein the type and amount of fertilizer positioned on the tape member is chosen based upon the soil type of the field wherein the tape member will be planted.

21. The method of claim 17 wherein insecticide is positioned on the tape member.

22. The method of claim 20 wherein the type and amount of insecticide is chosen based upon the soil type of the field wherein the tape member will be planted.

23. The method of claim 17 wherein the fertilizer is positioned between the seeds.

24. The method of claim 17 wherein the tape material is comprised of a fertilizer material.
